(19) United States
(12) Patent Application Publication
(10) Pub. No.: US 2014/0088236 A1
(43) Pub. Date: Mar. 27, 2014

(54) POLY(PHENYLENE ETHER) COMPOSITION AND ARTICLE

(71) Applicants: Christopher Ziegler, Rensselaer, NY (US); Kristopher Rexius, East Greenbush, NY (US)

(72) Inventors: Christopher Ziegler, Rensselaer, NY (US); Kristopher Rexius, East Greenbush, NY (US)

(21) Appl. No.: 13/625,102

(22) Filed: Sep. 24, 2012

(51) Int. Cl. C08L 51/04

(52) U.S. Cl. 524/504; 525/68

(57) ABSTRACT

A composition includes 15 to 35 weight percent of a poly(phenylene ether) having an intrinsic viscosity of 0.29 to 0.43 deciliter per gram, and 65 to 85 weight percent of a rubber-modified polystyrene. The composition exhibits improved heat resistance relative to acrylonitrile-butadiene-styrene copolymer (ABS) while maintaining comparable levels of melt flow, impact resistance, and tensile strength. Articles such as electrical housings can be molded from the composition.

### BACKGROUND OF THE INVENTION

Acrylonitrile-butadiene-styrene copolymer, also known as ABS, is a plastic commonly used in automotive exteriors, sporting goods, medical devices, and electrical housings, among other articles. Properties including melt flow, impact resistance, and tensile strength make ABS attractive for these applications. Further, ABS can be molded at relatively low temperatures, typically between 200 and 230° C. Although a low glass transition temperature aids in processing and molding ABS, it reduces the maximum temperature at which articles molded from ABS can be used. For articles molded from general purpose ABS, this maximum use temperature is approximately 80° C. “High heat” ABS materials exist, but they typically achieve their higher heat resistance by reducing polybutadiene content and thereby sacrificing impact strength relative to general purpose ABS. For some molded articles, such as electrical housings, appliance casings, automotive interior articles, and, generally, thin wall articles, there is a need for compositions that improve the heat resistance of general purpose ABS without significantly compromising melt flow, impact resistance, and tensile strength.

### BRIEF SUMMARY OF EMBODIMENTS OF THE INVENTION

One embodiment is a composition comprising: 15 to 35 weight percent poly(phenylene ether) having an intrinsic viscosity of 0.29 to 0.43 deciliter per gram at 25° C. in chloroform; and 65 to 85 weight percent rubber-modified polystyrene; wherein all weight percents are based on the total weight of the composition.

Another embodiment is a composition comprising: 16 to 31 weight percent, based on the total weight of the composition, of a poly(2,6-dimethyl-1,4-phenylene ether) having an intrinsic viscosity of 0.35 to 0.43 deciliter per gram, measured at 25° C. in chloroform; 67 to 83 weight percent, based on the total weight of the composition, of a rubber-modified polystyrene comprising, based on the weight of the rubber-modified polystyrene, 85 to 95 weight percent polystyrene and 5 to 15 weight percent polybutadiene; and 0.8 to 3 weight percent, based on the total weight of the composition, of an additive selected from the group consisting of stabilizers, mold release agents, lubricants, processing aids, drip retardants, nucleating agents, UV blockers, dyes, pigments, antioxidants, anti-static agents, blowing agents, metal deactivators, antiblocking agents, and combinations thereof, wherein the sum of the poly(phenylene ether) and the rubber-modified polystyrene is 95 to 99.5 weight percent, based on the total weight of the composition; wherein the composition comprises 0 to 1 weight percent total of fillers, flame retardants, unhydrogenated block copolymers of an alkenyl aromatic monomer and a conjugated diene, and hydrogenated block copolymers of an alkenyl aromatic monomer and a conjugated diene.

Another embodiment is an article comprising a composition comprising: 15 to 35 weight percent poly(phenylene ether) having an intrinsic viscosity of 0.29 to 0.43 deciliter per gram at 25° C. in chloroform; and 65 to 85 weight percent rubber-modified polystyrene; wherein all weight percents are based on the total weight of the composition.

These and other embodiments are described in detail below.

### DETAILED DESCRIPTION OF THE INVENTION

The present inventors have determined that certain poly(phenylene ether) compositions exhibit improved heat resistance relative to ABS while maintaining comparable levels of melt flow, impact resistance, and tensile strength. Thus, one embodiment is a composition comprising: 15 to 35 weight percent poly(phenylene ether) having an intrinsic viscosity of 0.29 to 0.43 deciliter per gram; and 65 to 85 weight percent rubber-modified polystyrene; wherein all weight percents are based on the total weight of the composition.

The composition comprises a poly(phenylene ether). Suitable poly(phenylene ether)s include those comprising repeating structural units having the formula

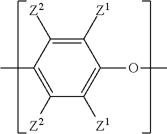

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each occurrence of Z² is independently hydrogen, halogen, unsubstituted or substituted C₁-C₁₂, hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself; or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. As one example, Z¹ can be a di-n-butylaminomethyl group formed by reaction of a terminal 3,5-dimethyl-1,4-phenyl group with the di-n-butylamine component of an oxidative polymerization catalyst.

The poly(phenylene ether) has an intrinsic viscosity of 0.29 to 0.43 deciliter per gram, measured at 25° C. in chloroform. Intrinsic viscosity can be measured by Ubbelohde viscometer. Within the range of 0.29 to 0.43 deciliter per gram, the poly(phenylene ether) intrinsic viscosity can be 0.35 to 0.43 deciliter per gram, specifically 0.37 to 0.43 deciliter per gram.

In some embodiments, the poly(phenylene ether) is essentially free of incorporated diphenoquinone residues. In the context, “essentially free” means that the fewer than 1 weight percent of poly(phenylene ether) molecules comprise the residue of a diphenoquinone. As described in U.S. Pat. No. 3,306,874 to Hay, synthesis of poly(phenylene ether) by oxidative polymerization of monohydric phenol yields not only the desired poly(phenylene ether) but also a diphenoquinone as side product. For example, when the monohydric phenol is 2,6-dimethylphenol, 3,3′,5,5′-tetramethyldiphenoquinone is generated. Typically, the diphenoquinone is “reequilibrated” into the poly(phenylene ether) (i.e., the diphenoquinone is incorporated into the poly(phenylene ether) structure) by heating the polymerization reaction mixture to yield a poly(phenylene ether) comprising terminal or internal diphenoquinone residues). For example, when a poly(phenylene ether) is prepared by oxidative polymerization of 2,6-dimethylphenol to yield poly(2,6-dimethyl-1,4-phenylene ether) and 3,3′,5,5′-tetramethyldiphenoquinone, reequilibration of the reaction mixture can produce a poly(phenylene ether) with terminal and internal residues of incorporated diphenoquinone. However, such reequilibration reduces the molecular weight of the poly(phenylene ether). Accordingly, when a higher molecular weight poly(phenylene ether) is desired, it may be desirable to separate the diphenoquinone from the poly(phenylene ether) rather than reequilibrating the diphenoquinone into the poly(phenylene ether) chains. Such a separation can be achieved, for example, by precipitation of the poly(phenylene ether) in a solvent or solvent mixture in which the poly(phenylene ether) is insoluble and the diphenoquinone is soluble. For example, when a poly(phenylene ether) is prepared by oxidative polymerization of 2,6-dimethylphenol in toluene to yield a toluene solution comprising poly(2,6-dimethyl-1,4-phenylene ether) and 3,3′,5,5′-tetramethyldiphenoquinone, a poly(2,6-dimethyl-1,4-phenylene ether) essentially free of diphenoquinone can be obtained by mixing 1 volume of the toluene solution with 1 to 4 volumes of methanol or a methanol/water mixture. Alternatively, the amount of diphenoquinone side-product generated during oxidative polymerization can be minimized (e.g., by initiating oxidative polymerization in the presence of less than 10 weight percent of the monohydric phenol and adding at least 95 weight percent of the monohydric phenol over the course of at least 50 minutes), and/or the reequilibration of the diphenoquinone into the poly(phenylene ether) chain can be minimized (e.g., by isolating the poly(phenylene ether) no more than 200 minutes after termination of oxidative polymerization). These approaches are described in U.S. Pat. No. 8,025,158 to Delsman et al. In an alternative approach utilizing the temperature-dependent solubility of diphenoquinone in toluene, a toluene solution containing diphenoquinone and poly(phenylene ether) can be adjusted to a temperature of about 25° C., at which diphenoquinone is poorly soluble but the poly(phenylene ether) is soluble, and the insoluble diphenoquinone can be removed by solid-liquid separation (e.g., filtration).

In some embodiments, the poly(phenylene ether) comprises 2,6-dimethyl-1,4-phenylene ether units, 2,3,6-trimethyl-1,4-phenylene ether units, or a combination thereof. In some embodiments, the poly(phenylene ether) is a poly(2,6-dimethyl-1,4-phenylene ether). In some embodiments, the poly(phenylene ether) comprises a poly(2,6-dimethyl-1,4-phenylene ether) having an intrinsic viscosity of 0.35 to 0.43 deciliter per gram, measured at 25° C. in chloroform.

The poly(phenylene ether) can comprise molecules having aminoalkyl-containing end group(s), typically located in a position ortho to the hydroxy group. Also frequently present are tetramethyldiphenoquinone (TMDQ) end groups, typically obtained from 2,6-dimethylphenol-containing reaction mixtures in which tetramethyldiphenoquinone by-product is present. The poly(phenylene ether) can be in the form of a homopolymer, a copolymer, a graft copolymer, an ionomer, or a block copolymer, as well as combinations thereof.

The composition comprises the poly(phenylene ether) in an amount of 15 to 35 weight percent, based on the total weight of the composition. Within this range, the poly(phenylene ether) amount can be 16 to 31 weight percent.

In addition to the poly(phenylene ether), the composition comprises a rubber-modified polystyrene. The rubber-modified polystyrene comprises polystyrene and polybutadiene. Rubber-modified polystyrenes are sometimes referred to as “high-impact polystyrenes” or “HIPS”. In some embodiments, the rubber-modified polystyrene comprises 80 to 96 weight percent polystyrene, specifically 85 to 95 weight percent polystyrene; and 4 to 20 weight percent polybutadiene, specifically 5 to 15 weight percent polybutadiene, based on the weight of the rubber-modified polystyrene. In some embodiments, the rubber-modified polystyrene has an effective gel content of 10 to 35 percent. Suitable rubber-modified polystyrenes are commercially available as, for example, HIPS3190 from SABIC Innovative Plastics.

The composition comprises the rubber-modified polystyrene in an amount of 65 to 85 weight percent, specifically 67 to 83 weight percent, based on the total weight of the composition.

In some embodiments, the sum of the poly(phenylene ether) and the rubber-modified polystyrene is 95 to 99.5 weight percent, based on the total weight of the composition.

The composition can, optionally, further comprise one or more additives known in the thermoplastics art. For example, the composition can, optionally, further comprise an additive chosen from stabilizers, mold release agents, lubricants, processing aids, drip retardants, nucleating agents, UV blockers, dyes, pigments, antioxidants, anti-static agents, blowing agents, mineral oil, metal deactivators, antiblocking agents, and the like, and combinations thereof. When present, such additives are typically used in a total amount of less than or equal to 5 weight percent, specifically 0.5 to 5 weight percent, more specifically 0.8 to 3 weight percent, based on the total weight of the composition.

In some embodiments, the composition comprises 0.2 to 2 weight percent linear low density polyethylene as a mold release agent and/or lubricant. In some embodiments, the composition comprises 0.05 to 0.5 weight percent of a trihydrocarbyl phosphite, such as triisodecyl phosphite or tris(2,4-di-t-butylphenyl) phosphite, as an antioxidant. In some embodiments, the composition comprises 0.05 to 0.5 weight percent zinc sulfide as a stabilizer. In some embodiments, the composition comprises 0.05 to 0.5 weight percent magnesium oxide and/or zinc oxide as a stabilizer.

The composition can, optionally, minimize or exclude components other than the required poly(phenylene ether) and rubber-modified polystyrene. For example, in some embodiments the composition comprises 0 to 1 weight percent fillers, including reinforcing fillers and non-reinforcing fillers. Within this range, the total amount of fillers can be up to 0.5 weight percent, specifically up to 0.1 weight percent. In some embodiments, the composition excludes fillers. It will be understood that the exclusion of fillers does exclude the use of small amounts of zinc sulfide, magnesium oxide, and zinc oxide as described above in the context of optional additives.

The composition can, optionally, minimize or exclude polyamides, polyolefins, and polyesters. For example, in some embodiments, the composition comprises 0 to 1 weight percent total of polyamides, polyolefins, and polyesters. Within this range, the total amount of polyamides, polyolefins, and polyesters can be up to 0.5 weight percent, specifically up to 0.1 weight percent. In some embodiments, the composition excludes polyamides, polyolefins, and polyesters.

The composition can, optionally, minimize or exclude styrenic block copolymers. For example, in some embodiments, the composition comprises 0 to 1 weight percent total of unhydrogenated block copolymers of an alkenyl aromatic monomer and a conjugated diene, and hydrogenated block copolymers of an alkenyl aromatic monomer and a conjugated diene. Within this range, the total amount of unhydrogenated and hydrogenated block copolymers can be up to 0.5 weight percent, specifically up to 0.1 weight percent. In some embodiments, the composition excludes unhydrogenated and hydrogenated block copolymers.

The composition can, optionally, minimize or exclude flame retardants. For example, in some embodiments, the composition comprises 0 to 1 weight percent of flame retardant. Within this range, the total amount of flame retardant can be up to 0.5 weight percent, specifically up to 0.1 weight percent. In some embodiments, the composition excludes flame retardants. Flame retardants that can be minimized or excluded include, for example, organophosphate esters (such as resorcinol bis(diphenyl phosphate) and bisphenol A bis(diphenyl phosphate)), metal dialkylphosphinates (such as aluminum tri(diethylphosphinate)), nitrogen-containing flame retardants (such as melamine phosphate, melamine pyrophosphate, melamine polyphosphate, and melamine cyanurate), metal hydroxides (such as magnesium hydroxide and aluminum hydroxide), and combinations thereof.

The composition can, optionally, minimize or exclude halogens. For example, in some embodiments, the composition comprises 0 to 0.1 weight percent of halogens. Within this range, the total amount of halogens can be up to 0.05 weight percent, specifically up to 0.01 weight percent. In some embodiments, the composition excludes halogens.

The composition exhibits improved heat resistance relative to ABS while maintaining comparable levels of melt flow, impact resistance, and tensile strength. Specifically, in some embodiments the composition exhibits a heat deflection temperature of at least 90° C., measured according to ASTM D648-07 at 1.82 megapascals and 3.2 millimeters thickness, a melt volume flow rate of at least 15 centimeter³/10 minutes, measured according to ASTM D1238-04 at 280° C. and 5 kilogram load, a notched Izod impact strength of at least 250 joules/meter, measured at 23° C. according to ASTM D256-10 using a 2.71 joule hammer and 3.2 millimeter bar thickness, and a tensile stress at yield value of at least 42 megapascals, measured at 23° C. according to ASTM D638-08, using a test speed of 50 millimeters/minute and a Type I bar having a thickness of 3.2 millimeters. In some embodiments, the composition exhibits a heat deflection temperature of 90 to 110° C., specifically 90 to 111° C., measured according to ASTM D648-07 at 1.82 megapascals and 3.2 millimeters thickness, a melt volume flow rate of 15 to 30 centimeter³/10 minutes, specifically 15 to 27 centimeter³/10 minutes, measured according to ASTM D1238-04 at 280° C. and 5 kilogram load, a notched Izod impact strength of 250 to 280 joules/meter, specifically 260 to 272 joules/meter, measured at 23° C. according to ASTM D256-10 using a 2.71 joule hammer and 3.2 millimeter bar thickness, and a tensile stress at yield value of 42 to 52 megapascals, specifically 44 to 50 megapascals, measured at 23° C. according to ASTM D638-08, using a test speed of 50 millimeters/minute and a Type I bar having a thickness of 3.2 millimeters.

In a very specific embodiment, the composition comprises 15 to 35 weight percent, based on the total weight of the composition, of a poly(2,6-dimethyl-1,4-phenylene ether) having an intrinsic viscosity of 0.35 to 0.43 deciliter per gram; 65 to 85 weight percent, based on the total weight of the composition, of a rubber-modified polystyrene comprising, based on the weight of the rubber-modified polystyrene, 85 to 95 weight percent polystyrene and 5 to 15 weight percent polybutadiene; and 0.5 to 5 weight percent, based on the total weight of the composition, of an additive selected from the group consisting of stabilizers, mold release agents, lubricants, processing aids, drip retardants, nucleating agents, UV blockers, dyes, pigments, antioxidants, anti-static agents, blowing agents, mineral oil, metal deactivators, antiblocking agents, and combinations thereof; wherein the sum of the poly(phenylene ether) and the rubber-modified polystyrene is 95 to 99.5 weight percent, based on the total weight of the composition; wherein the composition comprises 0 to 1 weight percent total of (or excludes) fillers, flame retardants, unhydrogenated block copolymers of an alkenyl aromatic monomer and a conjugated diene, and hydrogenated block copolymers of an alkenyl aromatic monomer and a conjugated diene.

The invention extends to articles comprising the composition. Specific articles benefiting from the increased heat resistance of the composition include electrical housings, appliance casings, automotive interior articles, and, generally, thin wall articles. One embodiment is an article comprising a composition comprising: 15 to 35 weight percent poly(phenylene ether) having an intrinsic viscosity of 0.29 to 0.43 deciliter per gram; and 65 to 85 weight percent rubber-modified polystyrene; wherein all weight percents are based on the total weight of the composition. All of the compositional variations describe above apply as well to articles comprising the composition. In a very specific embodiment of the article, the poly(phenylene ether) comprises a poly(2,6-dimethyl-1,4-phenylene ether); the poly(phenylene ether) has an intrinsic viscosity of 0.35 to 0.43 deciliter per gram at 25° C. in chloroform; the poly(phenylene ether) amount is 16 to 31 weight percent; the rubber-modified polystyrene comprises, based on the weight of the rubber-modified polystyrene, 85 to 95 weight percent polystyrene and 5 to 15 weight percent polybutadiene; the rubber-modified polystyrene amount is 67 to 83 weight percent; the sum of the poly(phenylene ether) amount and the rubber-modified polystyrene amount is 95 to 99.5 weight percent; the composition further comprises 0.8 to 3 weight percent of an additive selected from the group consisting of stabilizers, mold release agents, lubricants, processing aids, drip retardants, nucleating agents, UV blockers, dyes, pigments, antioxidants, anti-static agents, blowing agents, mineral oil, metal deactivators, antiblocking agents, and combinations thereof; and the composition comprises 0 to 1 weight percent total of fillers, flame retardants, unhydrogenated block copolymers of an alkenyl aromatic monomer and a conjugated diene, and hydrogenated block copolymers of an alkenyl aromatic monomer and a conjugated diene.

All ranges disclosed herein are inclusive of the endpoints, and the endpoints are independently combinable with each other. Each range disclosed herein constitutes a disclosure of any point or sub-range lying within the disclosed range.

The invention includes at least the following embodiments.

### Embodiment 1

A composition comprising: 15 to 35 weight percent poly(phenylene ether) having an intrinsic viscosity of 0.29 to 0.43 deciliter per gram at 25° C. in chloroform; and 65 to 85 weight percent rubber-modified polystyrene; wherein all weight percents are based on the total weight of the composition.

### Embodiment 2

The composition of claim 1, exhibiting a heat deflection temperature of at least 90° C., measured according to ASTM D648-07 at 1.82 megapascals and 3.2 millimeters thickness, a melt volume flow rate of at least 15 centimeter³/10 minutes, measured according to ASTM D1238-04 at 280° C. and 5 kilogram load, a notched Izod impact strength of at least 250 joules/meter, measured at 23° C. according to ASTM D256-10 using a 2.71 joule hammer and 3.2 millimeter bar thickness, and a tensile stress at yield value of at least 42 megapascals, measured at 23° C. according to ASTM D638-08, using a test speed of 50 millimeters/minute and a Type I bar having a thickness of 3.2 millimeters.

### Embodiment 3

The composition of claim 1, exhibiting a heat deflection temperature of 90 to 110° C., measured according to ASTM D648-07 at 1.82 megapascals and 3.2 millimeters thickness, a melt volume flow rate of 15 to 30 centimeter³/10 minutes, measured according to ASTM D1238-04 at 280° C. and 5 kilogram load, a notched Izod impact strength of 250 to 280 joules/meter, measured at 23° C. according to ASTM D256-10 using a 2.71 joule hammer and 3.2 millimeter bar thickness, and a tensile stress at yield value of 42 to 52 megapascals, measured at 23° C. according to ASTM D638-08, using a test speed of 50 millimeters/minute and a Type I bar having a thickness of 3.2 millimeters.

### Embodiment 4

The composition of any of claims 1-3, wherein the poly(phenylene ether) is a poly(2,6-dimethyl-1,4-phenylene ether).

### Embodiment 5

The composition of any of claims 1-4, wherein the poly(phenylene ether) has an intrinsic viscosity of 0.35 to 0.43 deciliter per gram, measured at 25° C. in chloroform.

### Embodiment 6

The composition of any of claims 1-5, wherein the rubber-modified polystyrene comprises 80 to 96 weight percent polystyrene and 4 to 20 weight percent polybutadiene, based on the weight of the rubber-modified polystyrene.

### Embodiment 7

The composition of any of claims 1-5, wherein the rubber-modified polystyrene comprises 85 to 95 weight percent polystyrene and 5 to 15 weight percent polybutadiene, based on the weight of the rubber-modified polystyrene.

### Embodiment 8

The composition of any of claims 1-7, wherein the composition further comprises 0.5 to 5 weight percent of an additive selected from the group consisting of stabilizers, mold release agents, lubricants, processing aids, drip retardants, nucleating agents, UV blockers, dyes, pigments, antioxidants, anti-static agents, blowing agents, metal deactivators, antiblocking agents, and combinations thereof.

### Embodiment 9

The composition of any of claims 1-8, wherein the sum of the poly(phenylene ether) and the rubber-modified polystyrene is 95 to 99.5 weight percent.

### Embodiment 10

The composition of any of claims 1-9, comprising 0 to 1 weight percent total of reinforcing fillers and non-reinforcing fillers.

### Embodiment 11

The composition of any of claims 1-10, comprising 0 to 1 weight percent total of unhydrogenated block copolymers of an alkenyl aromatic monomer and a conjugated diene, and hydrogenated block copolymers of an alkenyl aromatic monomer and a conjugated diene.

### Embodiment 12

The composition of any of claims 1-11, comprising 0 to 1 weight percent of flame retardant.

### Embodiment 13

The composition of any of claims 1-12, comprising 0 to 0.1 weight percent halogens.

### Embodiment 14

The composition of claim 1, wherein the poly(phenylene ether) comprises a poly(2,6-dimethyl-1,4-phenylene ether); wherein the poly(phenylene ether) has an intrinsic viscosity of 0.35 to 0.43 deciliter per gram at 25° C. in chloroform; wherein the poly(phenylene ether) amount is 16 to 31 weight percent; wherein the rubber-modified polystyrene comprises, based on the weight of the rubber-modified polystyrene, 85 to 95 weight percent polystyrene and 5 to 15 weight percent polybutadiene; wherein the rubber-modified polystyrene amount is 67 to 83 weight percent; wherein the sum of the poly(phenylene ether) amount and the rubber-modified polystyrene amount is 95 to 99.5 weight percent; wherein the composition further comprises 0.8 to 3 weight percent of an additive selected from the group consisting of stabilizers, mold release agents, lubricants, processing aids, drip retardants, nucleating agents, UV blockers, dyes, pigments, antioxidants, anti-static agents, blowing agents, metal deactivators, antiblocking agents, and combinations thereof; wherein the composition comprises 0 to 1 weight percent total of fillers, flame retardants, unhydrogenated block copolymers of an alkenyl aromatic monomer and a conjugated diene, and hydrogenated block copolymers of an alkenyl aromatic monomer and a conjugated diene.

### Embodiment 14a

A composition comprising: 16 to 31 weight percent, based on the total weight of the composition, of a poly(2,6-dimethyl-1,4-phenylene ether) having an intrinsic viscosity of 0.35 to 0.43 deciliter per gram, measured at 25° C. in chloroform; 67 to 83 weight percent, based on the total weight of the composition, of a rubber-modified polystyrene comprising, based on the weight of the rubber-modified polystyrene, 85 to 95 weight percent polystyrene and 5 to 15 weight percent polybutadiene; and 0.8 to 3 weight percent, based on the total weight of the composition, of an additive selected from the group consisting of stabilizers, mold release agents, lubricants, processing aids, drip retardants, nucleating agents, UV blockers, dyes, pigments, antioxidants, anti-static agents, blowing agents, metal deactivators, antiblocking agents, and combinations thereof; wherein the sum of the poly(phenylene ether) and the rubber-modified polystyrene is 95 to 99.5 weight percent, based on the total weight of the composition; wherein the composition comprises 0 to 1 weight percent total of fillers, flame retardants, unhydrogenated block copolymers of an alkenyl aromatic monomer and a conjugated diene, and hydrogenated block copolymers of an alkenyl aromatic monomer and a conjugated diene.

### Embodiment 15

An article comprising a composition comprising: 15 to 35 weight percent poly(phenylene ether) having an intrinsic viscosity of 0.29 to 0.43 deciliter per gram at 25° C. in chloroform; and 65 to 85 weight percent rubber-modified polystyrene; wherein all weight percents are based on the total weight of the composition.

### Embodiment 16

The article of claim 15, wherein the poly(phenylene ether) comprises a poly(2,6-dimethyl-1,4-phenylene ether); wherein the poly(phenylene ether) has an intrinsic viscosity of 0.35 to 0.43 deciliter per gram at 25° C. in chloroform; wherein the poly(phenylene ether) amount is 16 to 31 weight percent; wherein the rubber-modified polystyrene comprises, based on the weight of the rubber-modified polystyrene, 85 to 95 weight percent polystyrene and 5 to 15 weight percent polybutadiene; wherein the rubber-modified polystyrene amount is 67 to 83 weight percent; wherein the sum of the poly(phenylene ether) amount and the rubber-modified polystyrene amount is 95 to 99.5 weight percent; wherein the composition further comprises 0.8 to 3 weight percent of an additive selected from the group consisting of stabilizers, mold release agents, lubricants, processing aids, drip retardants, nucleating agents, UV blockers, dyes, pigments, antioxidants, anti-static agents, blowing agents, metal deactivators, antiblocking agents, and combinations thereof; wherein the composition comprises 0 to 1 weight percent total of fillers, flame retardants, unhydrogenated block copolymers of an alkenyl aromatic monomer and a conjugated diene, and hydrogenated block copolymers of an alkenyl aromatic monomer and a conjugated diene.

The invention is further illustrated by the following non-limiting examples.

### Examples 1-4

### Comparative Examples 1-8

These examples illustrate that the present compositions exhibit heat resistance superior to ABS while maintaining comparable melt flow and ductility.

Components used to prepare the compositions are described in Table 1.

TABLE 1

| Component | Description |
|---|---|
| PPE 0.46 | Poly(2,6-dimethyl-1,4-phenylene ether), CAS Reg. No. 25134-01-4, |
| | having an intrinsic viscosity of 0.46 deciliter per gram measured in |
| | chloroform at 25° C.; obtained as PPO 646 from SABIC Innovative |
| | Plastics. |
| PPE 0.40 | Poly(2,6-dimethyl-1,4-phenylene ether), CAS Reg. No. 25134-01-4, |
| | having an intrinsic viscosity of 0.40 deciliter per gram measured in |
| | chloroform at 25° C., obtained as PPO 640 from SABIC Innovative |
| | Plastics. |
| HIPS | High impact polystyrene; CAS Reg. No. 9003-55-8, having a volume |
| | average butadiene particle diameter of 2.4 micrometers, a rubber content |
| | of 10 weight percent, a swell index of 17, and a mineral oil content of 1.5 |
| | weight percent, obtained as GEH HIPS 1897 from SABIC Innovative |
| | Plastics. |
| SBS | Polystyrene-polybutadiene-polystyrene triblock copolymer, CAS Reg. No. |
| | 9003-55-8, having a polystyrene content of 31%, obtained as KRATON |
| | D1101 from Kraton Performance Polymers, Inc. |
| LLDPE | Linear low density polyethylene, CAS Reg. No. 25087-34-7, having a |
| | density of 0.925 grams per cubic centimeter and a melt volume flow rate |
| | of 20 cubic centimeters per 10 minutes at 190° C. and 2.16 kilogram load, |
| | obtained as ESCORENE LL5100.09 from ExxonMobil. |
| TDP | Triisodecyl phosphite, CAS Reg. No. 25448-25-3, obtained as WESTON |
| | TDP from Chemtura. |
| MgO | Magnesium oxide, CAS Reg. No. 1309-48-4, obtained as KYOWAMAG |
| | 150 from Kyowa Chemical Co. Ltd. |
| ZnO | Zinc oxide, CAS Reg. No. 1314-13-2, obtained as ZINKWEISS |
| | HARZSIEGEL CF from Norzinco GmbH. |
| ZnS | Zinc sulfide, CAS Reg. No. 1314-98-3, obtained as SACHTOLITH HD-S |
| | from Sachtleben Chemie GmbH. |
| Mineral oil | Mineral oil, having a kinematic viscosity, measured at 40° C. of 64.5 to |
| | 69.7 millimeter²/second and a specific gravity, measured at 23° C., of 0.869 |
| | to 0.885; obtained as Kaydol White mineral oil from Sonneborn or |
| | Drakeol 35 from Penreco. |
| Antistat. | A mixture of sodium alkyl sulfonate, CAS Reg. No. 68608-15-1, and |
| | sodium sulfate, CAS Reg. No. 7757-82-6, the mixture having a melting |
| | point of about 220° C.; obtained as HOSTASTAT HS1 from Clariant. |
| ABS1 | An acrylonitrile-butadiene-styrene copolymer, CAS Reg. No. 9003-56-9, |
| | having a specific gravity of about 1.05 and a Vicat softening temperature |
| | of about 98° C. measured according to ASTM D 1525, Method B/50; |
| | obtained as CYCOLAC MG38 from SABIC Innovative Plastics. |
| ABS2 | Acrylonitrile-butadiene-styrene copolymer, CAS Reg. No. 9003-56-9, |
| | having a specific gravity of about 1.04 and a Vicat softening temperature |
| | of about 98° C. measured according to ASTM D 1525, Method B/50; |
| | obtained as CYCOLAC MG47 from SABIC Innovative Plastics. |
| ABS3 | Acrylonitrile-butadiene-styrene copolymer, CAS Reg. No. 9003-56-9, |
| | having a specific gravity of about 1.04 and a Vicat softening temperature |
| | of about 98° C. measured according to ASTM D 1525, Method B/50; |
| | obtained as CYCOLAC MG94 from SABIC Innovative Plastics. |
| ABS4 | Acrylonitrile-butadiene-styrene copolymer, CAS Reg. No. 9003-56-9, |
| | having a density of about 1.04 grams/centimeter³ and a Vicat softening |
| | temperature of about 95° C. measured according to ISO 306, Method |
| | B/50; obtained as TELURAN GP-35 from Styrolution. |
| ABS5 | Acrylonitrile-butadiene-styrene copolymer, CAS Reg. No. 9003-56-9, |
| | having a density of about 1.04 grams/centimeter and a Vicat softening |
| | temperature of about 96° C. measured according to ISO 306, Method |
| | B/50; obtained as TELURAN GP-22 from Styrolution. |

Compositions are summarized in Table 2, where component amounts are expressed in weight percent based on the total weight of the composition. Triisodecyl phosphite was used in these experiments, but tris(2,6-di-t-butylphenyl) phosphite could also have been used. Compositions were prepared from the individual components as follows. The components were compounded in a 30 millimeter internal diameter Werner & Pfleiderer ZSK twin-screw extruder operating at 300 revolutions per minute and a throughput of 18-20 kilograms per hour (40-45 pounds per hour). All components were added at the feed port of the extruder. The zone temperatures from feed port to die were 230° C./260° C./260° C. The extrudate was pelletized by strand cutting, and the pellets were dried at 80° C. for four hours prior to subsequent use for injection molding. Comparative Examples 4-8 correspond to ABS1-ABS5, respectively.

Melt flow and physical property values are reported in Table 2. Melt volume flow rate values, express in units of centimeter³/10 minutes, were determined according to ASTM D1238-04 at (1) a temperature of 280° C. and a load of 5 kilogram load, or (2) a temperature of 220° C. and a load of 10 kilogram load. Results are provided in the Table 2 rows labeled “MVR, 280/5 (cc/10 min)” and “MVR, 220/10 (cc/10 min)” Melt viscosity values, expressed in units of pascal-seconds, were measured at a shear rate of 1500 second⁻¹ and temperatures of 230° C. and 280° C. according to ASTM D 3835-02 using a capillary length to diameter ratio of 20:1, a capillary diameter of 1.0 mm, an entrance angle of 180 degrees, and a specimen form of pellets. Results are provided in the Table 2 rows labeled “Vise., 230 (Pa-s)” and “Vise., 280 (Pa-s)”. The poly(phenylene ether) compositions were injection molded into articles for physical property testing. Parts for ASTM testing were molded on a 120-Ton Van Dorn injection molding machine using a family tool. The barrel temperature was 280° C., and the mold temperature was 65° C. Physical property values are reported in Table 2. Notched Izod impact strength values, expressed in units of joules per meter, were measured at 23° C. according to ASTM D256-10 using a 2.71 joule hammer and 3.2 millimeter bars. Results are provided in the Table 2 row labeled “NII (J/m)”. Tensile stress at yield values, expressed in units of megapascals, were determined at 23° C. according to ASTM D638-08, using a test speed of 50 millimeters/minute and a Type I bar having a thickness of 3.2 millimeters. Results are provided in the Table 2 row labeled “TS at yield (MPa)”. Heat deflection temperature (HDT) values, expressed in units of degrees centigrade, were measured according to ASTM D648-07 on unannealed bars at (1) 0.45 megapascals using bars having a thickness of 3.2 millimeters, (2) 1.82 megapascals using bars having a thickness of 3.2 millimeters, (3) 0.45 megapascals using bars having a thickness of 6.4 millimeters, or (4) 1.82 megapascals using bars having a thickness of 6.4 millimeters. Results are provided in the Table 2 rows labeled “HDT, 0.45 MPa, 3.2 mm (° C.)”, “HDT, 1.82 MPa, 3.2 mm (° C.)”, “HDT, 0.45 MPa, 6.4 mm (° C.)”, and “HDT, 1.82 MPa, 6.4 mm (° C.)”.

The results in Table 2 show that Examples 1-4 exhibited heat deflection temperatures at 1.82 megapascals and 3.2 millimeters thickness of at least 90° C., melt volume flow rates at 280° C. and 5 kilogram load of at least 15 centimeter³/10 minutes, notched Izod impact strengths of at least 250 joules/meter, and tensile stress at yield values of at least 42 megapascals. This combination of properties was not exhibited by either the comparative poly(phenylene ether) blends of Comparative Examples 1-3 or the ABS materials of Comparative Examples 4-8.

TABLE 2

| | | | | | | |
|---|---|---|---|---|---|---|
| C. Ex. 1 | C. Ex. 2 | Ex. 1 | Ex. 2 | Ex. 3 | C. Ex. 3 | Ex. 4 |

COMPOSITIONS

| | | | | | | | |
|---|---|---|---|---|---|---|---|
| PPE 0.46 | 0.00 | 34.3 | 0.00 | 0.00 | 0.00 | 0.00 | 0.00 |
| PPE 0.40 | 23.31 | 0.00 | 32.87 | 18.78 | 23.48 | 37.56 | 28.17 |
| HIPS | 69.92 | 63.74 | 65.00 | 80.00 | 75.00 | 60.00 | 70.00 |
| LLDPE | 0.92 | 1.47 | 1.23 | 0.70 | 0.88 | 1.40 | 1.05 |
| TDP | 0.46 | 0.49 | 0.28 | 0.16 | 0.20 | 0.32 | 0.24 |
| ZnS | 0.14 | 0.00 | 0.28 | 0.16 | 0.20 | 0.32 | 0.24 |
| ZnO | 0.14 | 0.00 | 0.00 | 0.00 | 0.00 | 0.00 | 0.00 |
| MgO | 0.00 | 0.00 | 0.35 | 0.20 | 0.25 | 0.40 | 0.30 |
| Mineral Oil | 1.39 | 0.00 | 0.00 | 0.00 | 0.00 | 0.00 | 0.00 |
| Antistat. | 1.86 | 0.00 | 0.00 | 0.00 | 0.00 | 0.00 | 0.00 |
| SBS | 1.86 | 0.00 | 0.00 | 0.00 | 0.00 | 0.00 | 0.00 |
| ABS1 | 0.00 | 0.00 | 0.00 | 0.00 | 0.00 | 0.00 | 0.00 |
| ABS2 | 0.00 | 0.00 | 0.00 | 0.00 | 0.00 | 0.00 | 0.00 |
| ABS3 | 0.00 | 0.00 | 0.00 | 0.00 | 0.00 | 0.00 | 0.00 |
| ABS4 | 0.00 | 0.00 | 0.00 | 0.00 | 0.00 | 0.00 | 0.00 |
| ABS5 | 0.00 | 0.00 | 0.00 | 0.00 | 0.00 | 0.00 | 0.00 |

PROPERTIES

| | | | | | | | |
|---|---|---|---|---|---|---|---|
| MVR, 280/5 | 28.6 | 12.9 | 15.8 | 26.9 | 22.5 | 13.1 | 18.4 |
| (cc/10 min) | | | | | | | |
| MVR, 220/10 | — | — | — | — | — | — | — |
| (cc/10 min) | | | | | | | |
| Visc., 230 (Pa-s) | — | — | — | 222 | — | — | 320 |
| Visc., 280 (Pa-s) | — | — | — | 110 | — | — | 145 |
| NII (J/m) | 347 | 234 | 260 | 272 | 269 | 255 | 268 |
| TS at yield (MPa) | 41.0 | 49.0 | 49.9 | 44.4 | 46.5 | 52.9 | 47.9 |
| HDT, 0.45 MPa, | — | 120 | 121 | 107 | 112 | 127 | 116 |
| 3.2 mm (° C.) | | | | | | | |
| HDT, 1.82 MPa, | — | 105 | 106 | 93 | 98 | 111 | 102 |
| 3.2 mm (° C.) | | | | | | | |
| HDT, 0.45 MPa, | 101 | 121 | 124 | 114 | 115 | 130 | 121 |
| 64 mm (° C.) | | | | | | | |
| HDT, 1.82 MPa, | 98 | 112 | 115 | 105 | 108 | 118 | 112 |
| 64 mm (° C.) | | | | | | | |

| | | | | |
|---|---|---|---|---|
| C. Ex. 4 | C. Ex. 5 | C. Ex. 6 | C. Ex. 7 | C. Ex. 8 |

COMPOSITIONS

| | | | | | |
|---|---|---|---|---|---|
| PPE 0.46 | 0.00 | 0.00 | 0.00 | 0.00 | 0.00 |
| PPE 0.40 | 0.00 | 0.00 | 0.00 | 0.00 | 0.00 |
| HIPS | 0.00 | 0.00 | 0.00 | 0.00 | 0.00 |
| LLDPE | 0.00 | 0.00 | 0.00 | 0.00 | 0.00 |
| TDP | 0.00 | 0.00 | 0.00 | 0.00 | 0.00 |
| ZnS | 0.00 | 0.00 | 0.00 | 0.00 | 0.00 |
| ZnO | 0.00 | 0.00 | 0.00 | 0.00 | 0.00 |
| MgO | 0.00 | 0.00 | 0.00 | 0.00 | 0.00 |
| Mineral Oil | 0.00 | 0.00 | 0.00 | 0.00 | 0.00 |
| Antistat. | 0.00 | 0.00 | 0.00 | 0.00 | 0.00 |
| SBS | 0.00 | 0.00 | 0.00 | 0.00 | 0.00 |
| ABS1 | 100.00 | 0.00 | 0.00 | 0.00 | 0.00 |
| ABS2 | 0.00 | 100.00 | 0.00 | 0.00 | 0.00 |
| ABS3 | 0.00 | 0.00 | 100.00 | 0.00 | 0.00 |
| ABS4 | 0.00 | 0.00 | 0.00 | 100.00 | 0.00 |
| ABS5 | 0.00 | 0.00 | 0.00 | 0.00 | 100.00 |

PROPERTIES

| | | | | | |
|---|---|---|---|---|---|
| MVR, 280/5 | — | — | — | — | 25.9 |
| (cc/10 min) | | | | | |
| MVR, 220/10 | 15 | 18 | — | 34 | 19 |
| (cc/10 min) | | | | | |
| Visc., 230 (Pa-s) | — | — | — | — | 169 |
| Visc., 280 (Pa-s) | — | — | — | — | 98 |
| NII (J/m) | 373 | 320 | 240 | 240 | 126 |
| TS at yield (MPa) | — | — | — | 45 | 46 |
| HDT, 0.45 MPa, | 97 | 96 | 95 | 89 | 90 |
| 3.2 mm (° C.) | | | | | |
| HDT, 1.82 MPa, | 82 | 82 | 82 | 75 | 78 |
| 3.2 mm (° C.) | | | | | |
| HDT, 0.45 MPa, | — | — | — | — | — |
| 6.4 mm (° C.) | | | | | |
| HDT, 1.82 MPa, | — | — | — | — | — |
| 6.4 mm (° C.) | | | | | |

1. A composition comprising:
15 to 35 weight percent poly(phenylene ether) having an intrinsic viscosity of 0.29 to 0.43 deciliter per gram at 25° C. in chloroform; and
65 to 85 weight percent rubber-modified polystyrene;
wherein all weight percents are based on the total weight of the composition.

2. The composition of claim 1, exhibiting
a heat deflection temperature of at least 90° C., measured according to ASTM D648-07 at 1.82 megapascals and 3.2 millimeters thickness,
a melt volume flow rate of at least 15 centimeter³/10 minutes, measured according to ASTM D1238-04 at 280° C. and 5 kilogram load,
a notched Izod impact strength of at least 250 joules/meter, measured at 23° C. according to ASTM D256-10 using a 2.71 joule hammer and 3.2 millimeter bar thickness, and
a tensile stress at yield value of at least 42 megapascals, measured at 23° C. according to ASTM D638-08, using a test speed of 50 millimeters/minute and a Type I bar having a thickness of 3.2 millimeters.

3. The composition of claim 1, exhibiting
a heat deflection temperature of 90 to 110° C., measured according to ASTM D648-07 at 1.82 megapascals and 3.2 millimeters thickness,
a melt volume flow rate of 15 to 30 centimeter³/10 minutes, measured according to ASTM D1238-04 at 280° C. and 5 kilogram load,
a notched Izod impact strength of 250 to 280 joules/meter, measured at 23° C. according to ASTM D256-10 using a 2.71 joule hammer and 3.2 millimeter bar thickness, and
a tensile stress at yield value of 42 to 52 megapascals, measured at 23° C. according to ASTM D638-08, using a test speed of 50 millimeters/minute and a Type I bar having a thickness of 3.2 millimeters.

4. The composition of claim 1, wherein the poly(phenylene ether) is a poly(2,6-dimethyl-1,4-phenylene ether).

5. The composition of claim 1, wherein the poly(phenylene ether) has an intrinsic viscosity of 0.35 to 0.43 deciliter per gram, measured at 25° C. in chloroform.

6. The composition of claim 1, wherein the rubber-modified polystyrene comprises 80 to 96 weight percent polystyrene and 4 to 20 weight percent polybutadiene, based on the weight of the rubber-modified polystyrene.

7. The composition of claim 1, wherein the rubber-modified polystyrene comprises 85 to 95 weight percent polystyrene and 5 to 15 weight percent polybutadiene, based on the weight of the rubber-modified polystyrene.

8. The composition of claim 1, wherein the composition further comprises 0.5 to 5 weight percent of an additive selected from the group consisting of stabilizers, mold release agents, lubricants, processing aids, drip retardants, nucleating agents, UV blockers, dyes, pigments, antioxidants, anti-static agents, blowing agents, metal deactivators, antiblocking agents, and combinations thereof.

9. The composition of claim 8, wherein the sum of the poly(phenylene ether) and the rubber-modified polystyrene is 95 to 99.5 weight percent.

10. The composition of claim 1, comprising 0 to 1 weight percent total of reinforcing fillers and non-reinforcing fillers.

11. The composition of claim 1, comprising 0 to 1 weight percent total of unhydrogenated block copolymers of an alkenyl aromatic monomer and a conjugated diene, and hydrogenated block copolymers of an alkenyl aromatic monomer and a conjugated diene.

12. The composition of claim 1, comprising 0 to 1 weight percent of flame retardant.

13. The composition of claim 1, comprising 0 to 0.1 weight percent halogens.

14. A composition comprising:
16 to 31 weight percent, based on the total weight of the composition, of a poly(2,6-dimethyl-1,4-phenylene ether) having an intrinsic viscosity of 0.35 to 0.43 deciliter per gram, measured at 25° C. in chloroform;
67 to 83 weight percent, based on the total weight of the composition, of a rubber-modified polystyrene comprising, based on the weight of the rubber-modified polystyrene, 85 to 95 weight percent polystyrene and 5 to 15 weight percent polybutadiene; and
0.8 to 3 weight percent, based on the total weight of the composition, of an additive selected from the group consisting of stabilizers, mold release agents, lubricants, processing aids, drip retardants, nucleating agents, UV blockers, dyes, pigments, antioxidants, anti-static agents, blowing agents, metal deactivators, antiblocking agents, and combinations thereof;
wherein the sum of the poly(phenylene ether) and the rubber-modified polystyrene is 95 to 99.5 weight percent, based on the total weight of the composition;
wherein the composition comprises 0 to 1 weight percent total of fillers, flame retardants, unhydrogenated block copolymers of an alkenyl aromatic monomer and a conjugated diene, and hydrogenated block copolymers of an alkenyl aromatic monomer and a conjugated diene.

15. An article comprising a composition comprising:
15 to 35 weight percent poly(phenylene ether) having an intrinsic viscosity of 0.29 to 0.43 deciliter per gram at 25° C. in chloroform; and
65 to 85 weight percent rubber-modified polystyrene;
wherein all weight percents are based on the total weight of the composition.

16. The article of claim 15,
wherein the poly(phenylene ether) comprises a poly(2,6-dimethyl-1,4-phenylene ether);
wherein the poly(phenylene ether) has an intrinsic viscosity of 0.35 to 0.43 deciliter per gram at 25° C. in chloroform;
wherein the poly(phenylene ether) amount is 16 to 31 weight percent;
wherein the rubber-modified polystyrene comprises, based on the weight of the rubber-modified polystyrene, 85 to 95 weight percent polystyrene and 5 to 15 weight percent polybutadiene;
wherein the rubber-modified polystyrene amount is 67 to 83 weight percent;
wherein the sum of the poly(phenylene ether) amount and the rubber-modified polystyrene amount is 95 to 99.5 weight percent;
wherein the composition further comprises 0.8 to 3 weight percent of an additive selected from the group consisting of stabilizers, mold release agents, lubricants, processing aids, drip retardants, nucleating agents, UV blockers, dyes, pigments, antioxidants, anti-static agents, blowing agents, metal deactivators, antiblocking agents, and combinations thereof;
wherein the composition comprises 0 to 1 weight percent total of fillers, flame retardants, unhydrogenated block copolymers of an alkenyl aromatic monomer and a conjugated diene, and hydrogenated block copolymers of an alkenyl aromatic monomer and a conjugated diene.
